(19) United States
(12) Patent Application Publication
(10) Pub. No.: US 2021/0216362 A1
(43) Pub. Date: Jul. 15, 2021

(54) GROUPING SYSTEMS MANAGEMENT OPERATIONS TO MINIMIZE DOWNTIME

(71) Applicant: LENOVO ENTERPRISE SOLUTIONS (SINGAPORE) PTE. LTD., Singapore (SG)

(72) Inventors: DAVID B. ROBERTS, NEWCASTLE, ME (US); FRED A. BOWER, III, DURHAM, NC (US); ANDREW J. SLOMA, AUSTIN, TX (US); JOSEPH E. SANKAR, CARY, NC (US)

(21) Appl. No.: 16/739,011

(22) Filed: Jan. 9, 2020

(51) Int. Cl. G06F 9/48

(52) U.S. Cl. CPC G06F 9/4881; G06F 2209/486

(57) ABSTRACT

Grouping systems management operations to minimize downtime including: receiving a first request to perform a first systems management operation requiring a first downtime inducing task; receiving, prior to performing the first downtime inducing task, a second request to perform a second systems management operation requiring a second downtime inducing task; delaying, in response to receiving the second request, the first downtime inducing task until completion of the first systems management operation and the second systems management operation; and performing the first downtime inducing task and the second downtime inducing task.

### BACKGROUND

### Field of the Invention

The field of the invention is data processing, or, more specifically, methods, apparatus, and products for grouping systems management operations to minimize downtime.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

### SUMMARY

Grouping systems management operations to minimize downtime may include: receiving a first request to perform a first systems management operation requiring a first downtime inducing task; receiving, prior to performing the first downtime inducing task, a second request to perform a second systems management operation requiring a second downtime inducing task; delaying, in response to receiving the second request, the first downtime inducing task until completion of the first systems management operation and the second systems management operation; and performing the first downtime inducing task and the second downtime inducing task.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a network diagram of a system configured for grouping systems management operations to minimize downtime according to embodiments of the present disclosure.

FIG. 2 is a block diagram of a computing device configured for grouping systems management operations to minimize downtime according to embodiments of the present disclosure.

FIG. 3 is a flowchart of an example method for grouping systems management operations to minimize downtime according to embodiments of the present disclosure.

FIG. 4 is a flowchart of an example method for grouping systems management operations to minimize downtime according to embodiments of the present disclosure.

FIG. 5 is a flowchart of an example method for grouping systems management operations to minimize downtime according to embodiments of the present disclosure.

FIG. 6 is a flowchart of an example method for grouping systems management operations to minimize downtime according to embodiments of the present disclosure.

FIG. 7 is a flowchart of an example method for grouping systems management operations to minimize downtime according to embodiments of the present disclosure.

### DETAILED DESCRIPTION

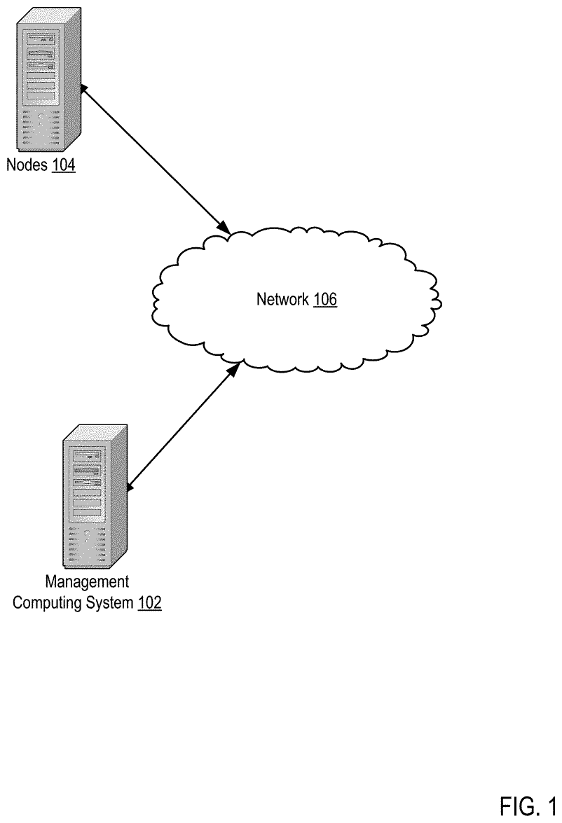

Exemplary methods, apparatus, and products for grouping systems management operations to minimize downtime in accordance with the present invention are described with reference to the accompanying drawings, beginning with FIG. 1. FIG. 1 sets forth a network diagram of a system configured for grouping systems management operations to minimize downtime according to embodiments of the present invention. The system of FIG. 1 includes a management computing system 102 and one or more nodes 104 communicatively coupled via the network 106. The management computing system 102 is configured to provision resources and tasks for performing systems management operations with respect to the nodes 104, network 106, or components thereof. The management computing system 102 is configured to receive and process systems management requests. A systems management request is a request to modify a particular component via a systems management operation. For example, systems management requests may include software updates, firmware updates, configuration changes, device or accelerator programming, or other tasks. The management computing system 102 may then provision the computational resources required to execute the systems management requests.

A systems management operation may require a downtime inducing task in order to fully effect any changes. A downtime inducing task is any task that makes one or more components, processes, or services (e.g., of the management computing system 102, the nodes 104, or the network 106) unavailable for a period of time. Examples of downtime inducing tasks include device restarts, operating system reboots, workload evacuations, quiescence of related subsystems, or other tasks. For example, a firmware update to a hardware component of a node 104 may require a restart of the node. Accordingly, the node 104 will be unavailable during the restart process. As another example, a workload of a field-programmable gate array (FPGA) may be offloaded while the FPGA is reprogrammed. Accordingly, the FPGA is unavailable to perform work during the reprogramming.

In existing implementations, systems management requests may be processed in the order that they are received. This may result in multiple restarts or periods of unavailability when processing multiple requests sequentially. Accordingly, the management computing system 102 is configured to group systems management operations to minimize downtime. The management computing system 102 may receive a first request to perform a first systems management operation requiring a first downtime inducing task. For example, assume that the first request comprises a request to perform a firmware update for a node 104, with the first downtime inducing task being a reboot of the node 104.

The management computing system 102 may then receive, prior to performing the first downtime inducing task, a second request to perform a second systems management operation requiring a second downtime inducing task. Continuing with the example above, the second request may be received during the firmware update process for the node 104, but prior to restarting the node. In response to receiving the second request, the management computing system 102 may delay the first downtime inducing task until completion of the first systems management operation and the second systems management operation. The management computing system 102 may then perform the first downtime inducing task and the second downtime inducing task (e.g., after completion of the first systems management operation and the second systems management operation).

The first downtime inducing task and the second downtime inducing task may comprise a same downtime inducing task. In other words, performing the first downtime inducing task fulfils the second downtime inducing task requirement. Continuing with the example above, assume that the first request comprises a request to perform a firmware update for a node 104, with the first downtime inducing task being a reboot of the node 104. Further assume that the second request comprises a request to perform a reconfiguration of one or more system parameters of the node 104, with the second downtime inducing task also being a reboot of the node 104. Accordingly, performing the first downtime inducing task and the second downtime inducing task would comprise performing a single reboot of the node 104 after the firmware update and the system parameter reconfigurations of the node 104 (e.g., the first systems management operation and the second systems management operation) are complete. The system then only experiences one period of downtime caused by a node 104 reboot. This provides reduced downtimes compared to existing solutions that would process the first request, initiate a first reboot, process the second request, and initiate a second reboot, resulting in two periods of downtime caused by a reboot of the node 104.

The first downtime inducing task and the second downtime inducing task may comprise different downtime inducing tasks. Assume that the first request comprises a request to perform a firmware update for a node 104, with the first downtime inducing task being a reboot of the node 104. Further assume that the second request comprises a request to reconfigure network parameters of the network 106, with the second downtime inducing task also being a reboot of the network 106. The management computing system 102 may determine that the first downtime inducing task and the second downtime inducing task are independent. Accordingly, the first downtime inducing task and the second downtime inducing task may be delayed in response to determining that the first downtime inducing task and the second downtime inducing task are independent. Downtime inducing tasks are independent when the performance of one downtime inducing task is not affected or hindered by performing the other downtime inducing task. In this example, a restart of a node 104 does not affect the ability to restart the network 106. Accordingly, performing the first downtime inducing task and the second downtime inducing task may be performed at least partially in parallel. Continuing with the above example, assume that restarting the network 106 results in 30 seconds of system downtime, while restarting the node 104 results in 10 seconds of downtime. By performing these operations in parallel, the total downtime is 30 seconds, as opposed to 40 seconds if performed sequentially.

The management computing system 102 may determine an estimated downtime associated with one or more of the first downtime inducing task or the second downtime inducing task. The estimated downtime may comprise an estimated time to perform the first downtime inducing task, the second downtime inducing task, or both. The estimated downtime may be based on one or more predefined values. Each type of downtime inducing task may comprise a predefined estimated time to complete. For example, a node 104 restart may have a predefined estimated time to complete of 10 seconds, while offloading an FGPA workload may have a predefined estimated time to complete of 15 seconds.

The estimated downtime may be determined based on one or more previous downtimes (e.g., an amount of time to previously complete a downtime inducing task). For example, the management computing system 102 may monitor an amount of time it takes to complete a downtime inducing task and record the amount of time. The amount of time may be recorded with one or more attributes of the downtime inducing task, including a type of task, a system configuration of one or more entities (e.g., devices, systems, etc.) performing the downtime inducing task. The estimated downtime for a given downtime inducing task may be determined as an average, median, or other aggregate of one or more previous downtimes associated with the given downtime inducing task. The estimated downtime may also be based on a system configuration (e.g. hardware and/or software) of the one or more entities performing the downtime inducing task. For example, the estimated downtime may be weighted or scaled based on a degree of similarity or performance capability relative to the previous downtimes. As an example, an estimated downtime to restart a node 104 with a solid state drive may be scaled to be reduced when estimated based on previous downtimes for restarting nodes with hard drives to reflect a performance increase afforded by the solid state drive.

The management computing system 102 may then compare the estimated downtime to a threshold. The management computing system 102 may perform the first downtime inducing task and the second downtime inducing task in response to the estimated downtime falling below the threshold and in response to a completion of the first systems management operation and the second systems management operation. Continuing with the example of a firmware update (first systems management operation) requiring a node 104 restart (first downtime inducing task) and a system parameter reconfiguration (second systems management operation) also requiring a node 104 restart (second downtime inducing task), assume an estimated downtime of 30 seconds and a threshold of 45 seconds. As the estimated downtime is less than the threshold, the management computing system 102 may initiate the node 104 restart once the firmware update and system parameter reconfiguration are complete.

The management computing system 102 may also determine that the estimated downtime meets the threshold. The management computing system 102 may then determine a deferral for one or more of the first downtime inducing task and the second downtime inducing task. The deferral comprises a time at which the first downtime inducing task and/or the second downtime inducing task will be performed. This allows downtime inducing tasks to be deferred until a later time where system downtime will impact fewer users or tasks (e.g., a period of reduced system usage). For example, assume a firmware update (first systems management operation) requiring a node 104 restart (first downtime inducing task) and a network parameter reconfiguration (second systems management operation) requiring a network 106 restart (second downtime inducing task). Also assume a 30 second estimated downtime for restarting the node 104, a 60 second estimate downtime for restarting the network, and a 45 second threshold. Here, the node 104 restart and the network 106 restart may be performed in parallel, resulting in a total estimated downtime of 60 seconds. As the estimated downtime exceeds the threshold, one or more of the node 104 restart and/or the network 106 restart may be deferred until the deferral time. For example, the management computing system 102 may defer only the network 106 restart that exceeds the threshold, allowing the node 104 restart to be performed without deferral. The management computing system 102 may also defer both the network 106 restart and the node 104 restart to be performed in parallel.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

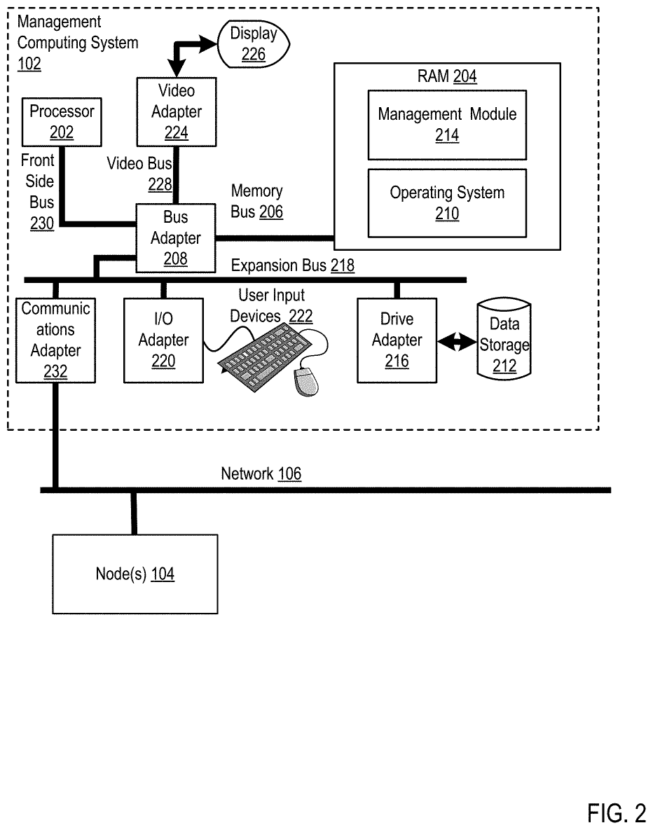

Grouping systems management operations in accordance with the present invention is generally implemented with computers, that is, with automated computing machinery. For further explanation, therefore, FIG. 2 sets forth a block diagram of automated computing machinery comprising an exemplary management computing system 102 configured for grouping systems management operations to minimize downtime according to embodiments of the present invention. The management computing system 102 of FIG. 2 includes at least one computer processor 202 or ‘CPU’ as well as random access memory 204 (RAM′) which is connected through a high speed memory bus 206 and bus adapter 208 to processor 202 and to other components of the management computing system 102.

Stored in RAM 204 is an operating system 210. Operating systems useful in computers configured for grouping systems management operations according to embodiments of the present invention include UNIX™, Linux™, Microsoft Windows™, AIX™, IBM's i OS™, and others as will occur to those of skill in the art. The operating system 208 in the example of FIG. 2 is shown in RAM 204, but many components of such software typically are stored in non-volatile memory also, such as, for example, on data storage 212, such as a disk drive. Also stored in RAM is the management module 214 a module for grouping systems management operations according to embodiments of the present invention.

The management computing system 102 of FIG. 2 includes disk drive adapter 216 coupled through expansion bus 218 and bus adapter 208 to processor 202 and other components of the management computing system 102. Disk drive adapter 216 connects non-volatile data storage to the management computing system 102 in the form of data storage 212. Disk drive adapters useful in computers configured for grouping systems management operations according to embodiments of the present invention include Integrated Drive Electronics (‘IDE’) adapters, Small Computer System Interface (SCSI′) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example management computing system 102 of FIG. 2 includes one or more input/output (′I/O′) adapters 220. I/O adapters implement user-oriented input/output through, for example, software drivers and computer hardware for controlling output to display devices such as computer display screens, as well as user input from user input devices 222 such as keyboards and mice. The example management computing system 102 of FIG. 2 includes a video adapter 224, which is an example of an I/O adapter specially designed for graphic output to a display device 226 such as a display screen or computer monitor. Video adapter 224 is connected to processor 202 through a high speed video bus 228, bus adapter 208, and the front side bus 230, which is also a high speed bus.

The exemplary management computing system 102 of FIG. 2 includes a communications adapter 232 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for grouping systems management operations to minimize downtime according to embodiments of the present invention include modems for wired dial-up communications, Ethernet (IEEE 802.3) adapters for wired data communications, and 802.11 adapters for wireless data communications.

The communications adapter 232 is communicatively coupled to a network 106 that also includes one or more affected devices 104, a knowledge base 108, and one or more potentially affected devices 112.

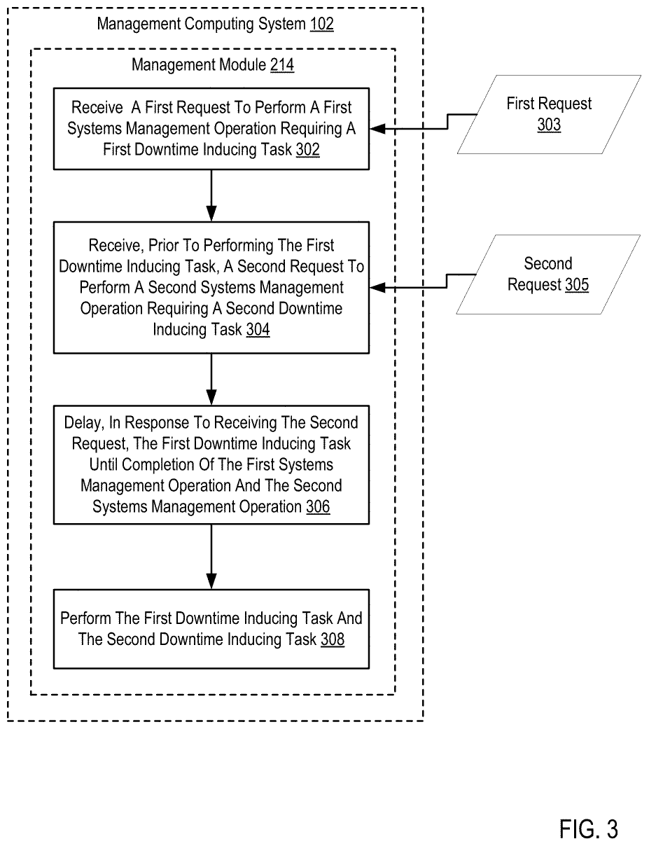

For further explanation, FIG. 3 sets forth a flow chart illustrating an exemplary method for grouping systems management operations to minimize downtime according to embodiments of the present invention that includes receiving 302 (e.g., by a management module 214 of a management computing system 102) a first request 303 to perform a first systems management operation requiring a first downtime inducing task. A downtime inducing task is any task that makes one or more components, processes, or services (e.g., of the management computing system 102, the nodes 104, or the network 106) unavailable for a period of time. Examples of downtime inducing tasks include device restarts, operating system reboots, workload evacuations, quiescence of related subsystems, or other tasks. For example, a firmware update to a hardware component of a node 104 may require a restart of the node. Accordingly, the node 104 will be unavailable during the restart process. As another example, a workload of a field-programmable gate array (FPGA) may be offloaded while the FPGA is reprogrammed. Accordingly, the FPGA is unavailable to perform work during the reprogramming.

The method of FIG. 3 also includes receiving 304 (e.g., by the management module 214 of the management computing system 102), prior to performing the first downtime inducing task, a second request 305 to perform a second systems management operation requiring a second downtime inducing task. Continuing with the example above, the second request may be received during the firmware update process for the node 104, but prior to restarting the node 104.

The first downtime inducing task and the second downtime inducing task may comprise a same downtime inducing task. In other words, performing the first downtime inducing task fulfils the second downtime inducing task requirement. Continuing with the example above, assume that the first request comprises a request to perform a firmware update for a node 104, with the first downtime inducing task being a reboot of the node 104. Further assume that the second request comprises a request to perform a reconfiguration of one or more system parameters of the node 104, with the second downtime inducing task also being a reboot of the node 104. Accordingly, performing the first downtime inducing task and the second downtime inducing task would comprise performing a single reboot of the node 104 after the firmware update and the system parameter reconfigurations of the node 104 (e.g., the first systems management operation and the second systems management operation) are complete. The system then only experiences one period of downtime caused by a node 104 reboot. This provides reduced downtimes compared to existing solutions that would process the first request, initiate a first reboot, process the second request, and initiate a second reboot, resulting in two periods of downtime caused by a reboot of the node 104.

The first downtime inducing task and the second downtime inducing task may comprise different downtime inducing tasks. Assume that the first request comprises a request to perform a firmware update for a node 104, with the first downtime inducing task being a reboot of the node 104. Further assume that the second request comprises a request to reconfigure network parameters of the network 106, with the second downtime inducing task also being a reboot of the network 106. The first downtime inducing task and the second downtime inducing task may be dependent or independent.

The method of FIG. 3 also includes delaying 306 (e.g., by the management module 214 of the management computing system 102), in response to receiving the second request 305, the first downtime inducing task until completion of the first systems management operation and the second systems management operation. The method of FIG. 3 also includes performing 308 (e.g., by the management module 214 of the management computing system 102), the first downtime inducing task and the second downtime inducing task (e.g., after completion of the first systems management operation and the second systems management operation). Where the first downtime inducing task and the second downtime inducing task are a same downtime inducing task, performing 308 the first downtime inducing task and the second downtime inducing task may comprise performing, as the first downtime inducing task and the second downtime inducing task, a single task. For example, where the first downtime inducing task and the second downtime inducing task are both a node 104 restart, performing 308 the first downtime inducing task and the second downtime inducing task may comprise performing a single node restart to effect both the first systems management operation and the second systems management operation. Where the first downtime inducing task and the second downtime inducing task are different and independent, performing 308 the first downtime inducing task and the second downtime inducing task may comprise performing 308 the first downtime inducing task and the second downtime inducing task at least partially in parallel.

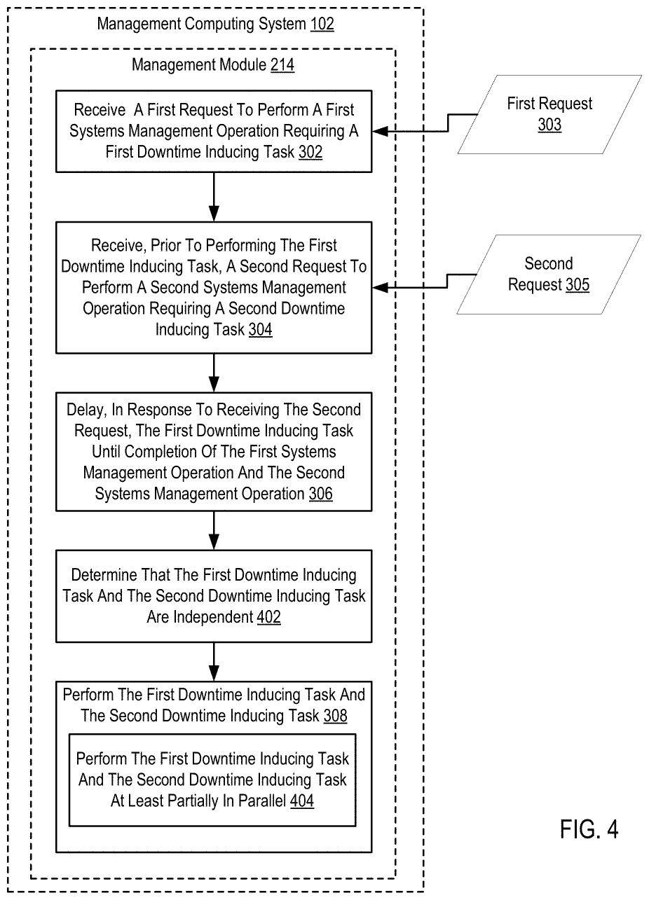

For further explanation, FIG. 4 sets forth a flow chart illustrating an exemplary method for grouping systems management operations to minimize downtime according to embodiments of the present invention that includes receiving 302 (e.g., by a management module 214 of a management computing system 102) a first request 303 to perform a first systems management operation requiring a first downtime inducing task; receiving 304 (e.g., by the management module 214 of the management computing system 102), prior to performing the first downtime inducing task, a second request 305 to perform a second systems management operation requiring a second downtime inducing task; delaying 306 (e.g., by the management module 214 of the management computing system 102), in response to receiving the second request 305, the first downtime inducing task until completion of the first systems management operation and the second systems management operation; and performing 308 (e.g., by the management module 214 of the management computing system 102), the first downtime inducing task and the second downtime inducing task.

FIG. 4 differs from FIG. 3 in that the method of FIG. 4 also includes determining 402 (e.g., by the management module 214 of the management computing system 102), that the first downtime inducing task and the second downtime inducing task are independent. Downtime inducing tasks are independent when the performance of one downtime inducing task is not affected or hindered by performing the other downtime inducing task. For example, a restart of a node 104 does not affect the ability to restart the network 106. Determining 402 that the first downtime inducing task and the second downtime inducing task are independent may comprise comparing the first downtime inducing task and the second downtime inducing task to a dependency chart or other encoding of downtime inducing task dependencies.

FIG. 4 differs from FIG. 3 in that performing 308 performing the first downtime inducing task and the second downtime inducing task comprises performing 404 the first downtime inducing task and the second downtime inducing task at least partially in parallel. Continuing with the above example, assume that restarting the network 106 results in 30 seconds of system downtime, while restarting the node 104 results in 10 seconds of downtime. By performing these operations in parallel, the total downtime is 30 seconds, as opposed to 40 seconds if performed sequentially.

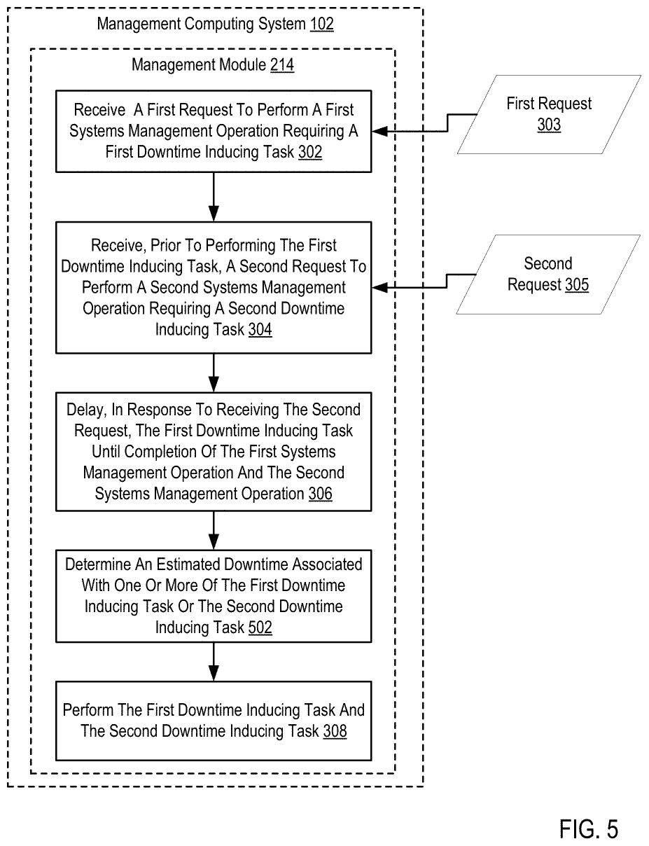

For further explanation, FIG. 5 sets forth a flow chart illustrating an exemplary method for grouping systems management operations to minimize downtime according to embodiments of the present invention that includes receiving 302 (e.g., by a management module 214 of a management computing system 102) a first request 303 to perform a first systems management operation requiring a first downtime inducing task; receiving 304 (e.g., by the management module 214 of the management computing system 102), prior to performing the first downtime inducing task, a second request 305 to perform a second systems management operation requiring a second downtime inducing task; delaying 306 (e.g., by the management module 214 of the management computing system 102), in response to receiving the second request 305, the first downtime inducing task until completion of the first systems management operation and the second systems management operation; and performing 308 (e.g., by the management module 214 of the management computing system 102), the first downtime inducing task and the second downtime inducing task.

FIG. 5 differs from FIG. 3 in that the method of FIG. 4 also includes determining 502 (e.g., by the management module 214 of the management computing system 102) an estimated downtime associated with one or more of the first downtime inducing task or the second downtime inducing task. The estimated downtime may comprise an estimated time to perform the first downtime inducing task, the second downtime inducing task, or both. The estimated downtime may be based on one or more predefined values. Each type of downtime inducing task may comprise a predefined estimated time to complete. For example, a node 104 restart may have a predefined estimated time to complete of 10 seconds, while offloading an FGPA workload may have a predefined estimated time to complete of 15 seconds.

The estimated downtime may be determined based on one or more previous downtimes (e.g., an amount of time to previously complete a downtime inducing task). For example, the management computing system 102 may monitor an amount of time it takes to complete a downtime inducing task and record the amount of time. The amount of time may be recorded with one or more attributes of the downtime inducing task, including a type of task, a system configuration of one or more entities (e.g., devices, systems, etc.) performing the downtime inducing task. The estimated downtime for a given downtime inducing task may be determined as an average, median, or other aggregate of one or more previous downtimes associated with the given downtime inducing task. The estimated downtime may also be based on a system configuration (e.g. hardware and/or software) of the one or more entities performing the downtime inducing task. For example, the estimated downtime may be weighted or scaled based on a degree of similarity or performance capability relative to the previous downtimes. As an example, an estimated downtime to restart a node 104 with a solid state drive may be scaled to be reduced when estimated based on previous downtimes for restarting nodes with hard drives to reflect a performance increase afforded by the solid state drive.

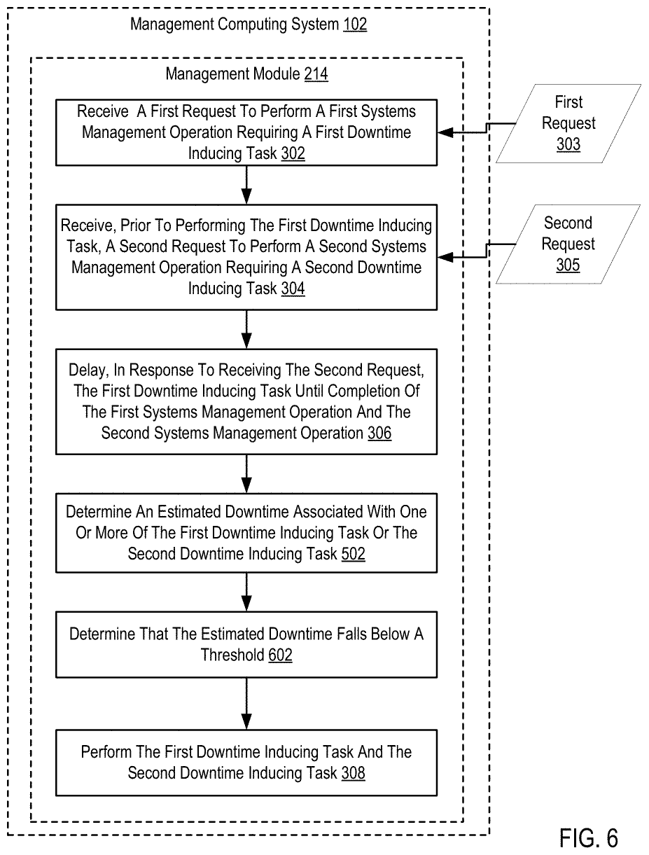

For further explanation, FIG. 6 sets forth a flow chart illustrating an exemplary method for grouping systems management operations to minimize downtime according to embodiments of the present invention that includes receiving 302 (e.g., by a management module 214 of a management computing system 102) a first request 303 to perform a first systems management operation requiring a first downtime inducing task; receiving 304 (e.g., by the management module 214 of the management computing system 102), prior to performing the first downtime inducing task, a second request 305 to perform a second systems management operation requiring a second downtime inducing task; delaying 306 (e.g., by the management module 214 of the management computing system 102), in response to receiving the second request 305, the first downtime inducing task until completion of the first systems management operation and the second systems management operation; determining 502 an estimated downtime associated with one or more of the first downtime inducing task or the second downtime inducing task; and performing 308 (e.g., by the management module 214 of the management computing system 102), the first downtime inducing task and the second downtime inducing task.

FIG. 6 differs from FIG. 5 in that the method of FIG. 6 also includes determining 602 that the estimated downtime falls below a threshold. Accordingly, performing 308 the first downtime inducing task and the second downtime inducing task may be performed in response to the estimated downtime falling below the threshold. Given the example of a firmware update (first systems management operation) requiring a node 104 restart (first downtime inducing task) and a system parameter reconfiguration (second systems management operation) also requiring a node 104 restart (second downtime inducing task), assume an estimated downtime of 30 seconds and a threshold of 45 seconds. As the estimated downtime is less than the threshold, the management computing system 102 may initiate the node 104 restart once the firmware update and system parameter reconfiguration are complete.

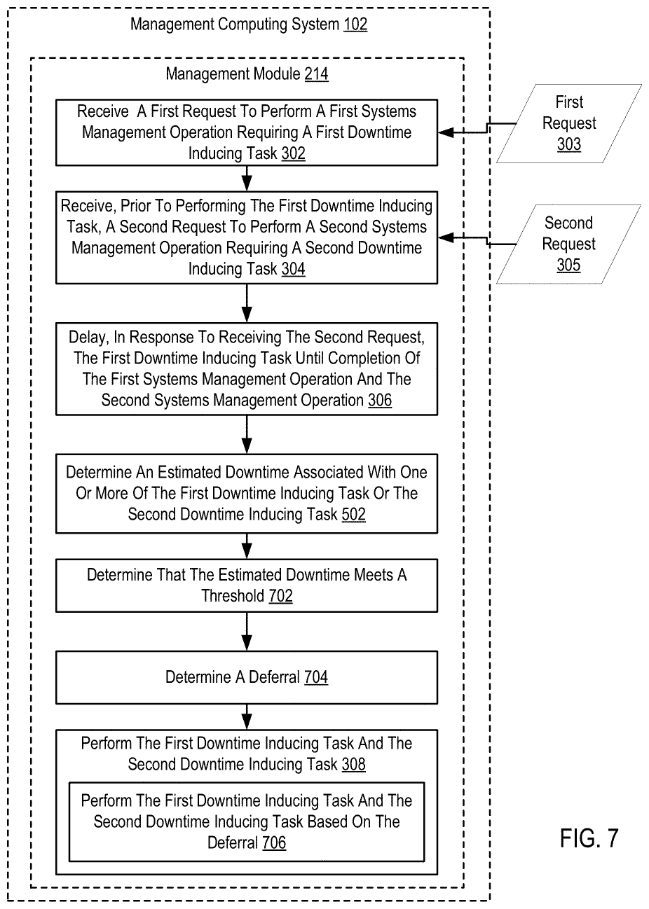

For further explanation, FIG. 7 sets forth a flow chart illustrating an exemplary method for grouping systems management operations to minimize downtime according to embodiments of the present invention that includes receiving 302 (e.g., by a management module 214 of a management computing system 102) a first request 303 to perform a first systems management operation requiring a first downtime inducing task; receiving 304 (e.g., by the management module 214 of the management computing system 102), prior to performing the first downtime inducing task, a second request 305 to perform a second systems management operation requiring a second downtime inducing task; delaying 306 (e.g., by the management module 214 of the management computing system 102), in response to receiving the second request 305, the first downtime inducing task until completion of the first systems management operation and the second systems management operation; determining 502 an estimated downtime associated with one or more of the first downtime inducing task or the second downtime inducing task; and performing 308 (e.g., by the management module 214 of the management computing system 102), the first downtime inducing task and the second downtime inducing task.

FIG. 7 differs from FIG. 5 in that the method of FIG. 7 also includes determining 702 that the estimated downtime meets the threshold. The method of FIG. 7 further differs from FIG. 5 in that the method of FIG. 7 also includes determining 704 (e.g., by the management module 214 of the management computing system 102) a deferral for one or more of the first downtime inducing task and the second downtime inducing task. The deferral comprises a time at which the first downtime inducing task and/or the second downtime inducing task will be performed. This allows downtime inducing tasks to be deferred until a later time where system downtime will impact fewer users or tasks (e.g., a period of reduced system usage). The deferral may be determined 704 based on a predefined deferral time (e.g., 2:00 am or another time). The deferral may also be determined 704 based on a predefined duration from the current time (e.g., a 4 hour deferral). The deferral may also be determined 704 based on a user defined deferral policy.

FIG. 7 differs from FIG. 5 in that performing 308 the first downtime inducing task and the second downtime inducing task comprises performing 706, based on the deferral, the first downtime inducing task and the second downtime inducing task. In other words, the first downtime inducing task and the second downtime inducing task are performed at the time determined by the deferral.

For example, assume a firmware update (first systems management operation) requiring a node 104 restart (first downtime inducing task) and a network parameter reconfiguration (second systems management operation) requiring a network 106 restart (second downtime inducing task). Also assume a 30 second estimated downtime for restarting the node 104, a 60 second estimate downtime for restarting the network, and a 45 second threshold. Here, the node 104 restart and the network 106 restart may be performed in parallel, resulting in a total estimated downtime of 60 seconds. As the estimated downtime exceeds the threshold, one or more of the node 104 restart and/or the network 106 restart may be deferred until the deferral time. For example, the management computing system 102 may defer only the network 106 restart that exceeds the threshold, allowing the node 104 restart to be performed without deferral. The management computing system 102 may also defer both the network 106 restart and the node 104 restart to be performed in parallel.

In view of the explanations set forth above, readers will recognize that the benefits of grouping systems management operations to minimize downtime according to embodiments of the present invention include:
Improved performance of a computing system by grouping systems management operations to minimize downtime caused by downtime inducing tasks.
Improved performance of a computing system through policy-based thresholds for determining when and how to defer downtime inducing tasks.
Improved performance of a computing system based on estimated downtimes caused by downtime inducing tasks.

Exemplary embodiments of the present invention are described largely in the context of a fully functional computer system for grouping systems management operations to minimize downtime. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method, the method comprising:
receiving a first request to perform a first systems management operation requiring a first downtime inducing task;
receiving, prior to performing the first downtime inducing task, a second request to perform a second systems management operation requiring a second downtime inducing task;
delaying, in response to receiving the second request, the first downtime inducing task until completion of the first systems management operation and the second systems management operation; and
performing the first downtime inducing task and the second downtime inducing task after completion of the first and second systems management operations.

2. The method of claim 1, wherein the second downtime inducing task required by the second systems management operation is the first downtime inducing task such that performing the first downtime inducing task fulfils the second downtime inducing task requirement of the second systems management operation.

3. The method of claim 1, further comprising:
determining that the first downtime inducing task and the second downtime inducing task are independent; and
wherein performing the first downtime inducing task and the second downtime inducing task comprises performing the first downtime inducing task and the second downtime inducing task at least partially in parallel.

4. The method of claim 1, further comprising determining an estimated downtime associated with one or more of the first downtime inducing task or the second downtime inducing task.

5. The method of claim 4, wherein the estimated downtime is determined based on one or more of: a system configuration or one or more previous downtimes.

6. The method of claim 4, wherein the first downtime inducing task and the second downtime inducing task are performed in response to determining that the estimated downtime falls below a threshold.

7. The method of claim 4, further comprising:
determining that the estimated downtime meets or exceeds a threshold; and
deferring one or more of the first downtime inducing task or the second downtime inducing task.

8. An apparatus, the apparatus comprising a computer processor, a non-volatile memory operatively coupled to the computer processor, the non-volatile memory storing computer program instructions that are configured to, when executed by the computer processor, cause the apparatus to perform operations comprising:
receiving a first request to perform a first systems management operation requiring a first downtime inducing task;
receiving, prior to performing the first downtime inducing task, a second request to perform a second systems management operation requiring a second downtime inducing task;
delaying, in response to receiving the second request, the first downtime inducing task until completion of the first systems management operation and the second systems management operation; and
performing the first downtime inducing task and the second downtime inducing task after completion of the first and second systems management operations.

9. The apparatus of claim 8, wherein the second downtime inducing task required by the second systems management operation is the first downtime inducing task such that performing the first downtime inducing task fulfils the second downtime inducing task requirement of the second systems management operation.

10. The apparatus of claim 8, wherein the operations further comprise:
determining that the first downtime inducing task and the second downtime inducing task are independent; and
wherein performing the first downtime inducing task and the second downtime inducing task comprises performing the first downtime inducing task and the second downtime inducing task at least partially in parallel.

11. The apparatus of claim 8, wherein the operations further comprise determining an estimated downtime associated with one or more of the first downtime inducing task or the second downtime inducing task.

12. The apparatus of claim 11, wherein the operations further comprise determining an estimated downtime associated with one or more of the first downtime inducing task or the second downtime inducing task.

13. The apparatus of claim 11, wherein the first downtime inducing task and the second downtime inducing task are performed in response to determining that the estimated downtime falls below a threshold.

14. The apparatus of claim 11, wherein the operations further comprise:
determining that the estimated downtime meets or exceeds a threshold; and
deferring one or more of the first downtime inducing task or the second downtime inducing task.

15. A computer program product, the computer program product comprising a non-volatile computer readable medium and computer program instructions stored therein that are configured to, when executed, cause a computer to perform operations comprising:
receiving a first request to perform a first systems management operation requiring a first downtime inducing task;
receiving, prior to performing the first downtime inducing task, a second request to perform a second systems management operation requiring a second downtime inducing task;
delaying, in response to receiving the second request, the first downtime inducing task until completion of the first systems management operation and the second systems management operation; and
performing the first downtime inducing task and the second downtime inducing task after completion of the first and second systems management operations.

16. The computer program product of claim 15, wherein the second downtime inducing task required by the second systems management operation is the first downtime inducing task such that performing the first downtime inducing task fulfils the second downtime inducing task requirement of the second systems management operation.

17. The computer program product of claim 15, wherein the operations further comprise:
determining that the first downtime inducing task and the second downtime inducing task are independent; and
wherein performing the first downtime inducing task and the second downtime inducing task comprises performing the first downtime inducing task and the second downtime inducing task at least partially in parallel.

18. The computer program product of claim 15, wherein the operations further comprise determining an estimated downtime associated with one or more of the first downtime inducing task or the second downtime inducing task.

19. The computer program product of claim 18, wherein the estimated downtime is determined based on one or more of: a system configuration or one or more previous downtimes.

20. The computer program product of claim 18, wherein the first downtime inducing task and the second downtime inducing task are performed in response to determining that the estimated downtime falls below a threshold.
